(19) United States
(12) Patent Application Publication
(10) Pub. No.: US 2003/0201055 A1
(43) Pub. Date: Oct. 30, 2003

(54) Method for manufacturing laminated LC filter

(76) Inventor: Seong Won Cho, Seoul (KR)

Correspondence Address: LOWE HAUPTMAN GILMAN & BERNER, LLP, Suite 310, 1700 Diagonal Road, Alexandria, VA, 22314, US

(21) Appl. No.: 10/164,701

(22) Filed: Jun. 10, 2002

(30) Foreign Application Priority Data
Apr. 29, 2002 (KR) 2002-23365

(51) Int. Cl. C03B 29/00

(52) U.S. Cl. 156/89.11

(57) ABSTRACT

Disclosed is a method for manufacturing a laminated LC filter, the method involving the steps of forming capacitor and inductor parts through separate sintering processes and then bonding the two parts using a glass-based adhesive. The use of the present method can solve problems of delamination and shape deformation caused by the difference in shrinkages occurring during a co-sintering process of the dielectric layer constituting the capacitor part and the magnetic layer constituting the inductor part. Also, since the method dose not use any extra buffer layer, there is no need to consider the shrinkage reduction and the composition of the buffer layer, and so the compositions of the dielectric and magnetic layers can be freely designed.

### BACKGROUND OF THE INVENTION

1. Field of the Invention

The present invention relates to a method for manufacturing a laminated LC filter, and more particularly to a method for manufacturing a laminated LC filter, which is capable of resolving problems generated due to the sintering shrinkage by primarily sintering two layers made of different kinds of materials, that is, dielectric and magnetic layers, separately, bonding the two layers and then secondarily sintering the bonded layer at a low temperature.

2. Description of the Related Art

Laminated LC filters include a laminated structure with an inductor part consisting of a plurality of magnetic layers and a capacitor part consisting of a plurality of dielectric layers. On main surfaces of the respective dielectric and magnetic layers are formed internal electrodes constituting capacitance elements and coils constituting inductance elements. Also, the internal electrode and the coil formed at each layer extend to connect to external terminals formed on lateral surfaces of the laminated structure, respectively.

Generally, such a laminated LC filter is manufactured by forming conductive patterns at corresponding main surfaces of respective dielectric and magnetic layers, laminating these layers, sintering the laminated structure and then forming external terminals at lateral surfaces of the sintered structure.

However, in the LC filter thus obtained, there occur very different sintering shrinkage and thermal expansion between the dielectric and magnetic layers, as well as there being low affinity between the layers. As a result, the LC filter has problems in that it undergoes undesired changes in its physical and electrical properties, that is, changes in the dielectric constant and magnetic permeability, and deformations of size and shape during the co-sintering process.

To resolve those problems, a buffer layer has been conventionally used in the manufacture of LC filters to reduce the difference in shrinkages between dielectric and magnetic layers. However, the deformation problem caused by the difference in shrinkages of different materials is difficult to completely solve by the use of only one buffer layer. Furthermore, the deterioration of electrical characteristics of parts is caused by the reduction of resistance based on buffer layer materials used (especially in case of including Ni and so on).

In this regard, as an improved method using buffer layers, a method using two buffer layers is disclosed in Japanese Patent Laid-Open Publication No. Heisei 6-176967. FIG. 1 illustrates an LC filter 10 manufactured by the method proposed in the above publication in cross-sectional view.

Referring to FIG. 1, between a capacitor part 1 and an inductor part 2, are further included a first buffer layer 3 adjacent to a dielectric layer constituting the capacitor part 1 and a second buffer layer 4 adjacent to a magnetic layer constituting the inductor part 2. Those two buffer layers 3 and 4 have compositions similar to those of the adjacent layers, that is, the dielectric layer and the magnetic layer, respectively, without including Ni. Accordingly, it is possible to prevent the reduction of resistance occurring due to segregation while more effectively reducing shrinkage.

However, in the above method, there is a problem in that it is difficult to form two buffer layers for reducing the difference in shrinkages between the capacitor and inductor parts during sintering. More clearly, dielectric layers can be made of materials selected from various materials including oxides such as TiO₂, NiO, CuO, Mn₃O₄ and so on, and magnetic layers can be also made of various materials such as oxides including Cu and/or Fe and Ni—Zn based ferrite and so on. Also, respective compositions of the buffer layers have to be selected considering the compositions of the associated capacitor and inductor parts made of different materials. Accordingly, the above method has a difficulty in determining the composition of buffer layers. Furthermore, on occasion (for example, in case that there is a large difference in composition between dielectric and magnetic layers, and particular elements such as Ni are not included in buffer layers), the selection of materials constituting dielectric or magnetic layers is limited.

Also, since in the conventional manufacture of LC filter, the dielectric and magnetic layers are still sintered at a high temperature of 1300° C. or more through a co-sintering method, diffusion of elements may occur between the dielectric layer and one buffer layer or between the magnetic layer and the other buffer layer. As a result, conventional methods have a problem in that such diffusion causes an undesired change in the dielectric constant of the dielectric layer and in the magnetic permeability of the magnetic layer, thereby leading to the deterioration of electrical characteristics of parts.

Therefore, in this technical field, a new laminated LC filter manufacturing method is required which is capable of preventing the structural distortion and the deterioration of electrical characteristics caused by shrinkage occurring during a co-sintering process without use of the buffer layer limited in its composition.

### SUMMARY OF THE INVENTION

Therefore, the present invention has been made in view of the above problems, and it is an object of the present invention to provide a method for manufacturing a laminated LC filter, which involves the steps of laminating dielectric and magnetic layers separately, sintering each laminated structure separately and then assembling two sintered resultants using a adhesive layer without use of a buffer layer having a particular composition.

In accordance with the present invention, the above and other objects can be accomplished by the provision of a method for manufacturing a laminated LC filter, comprising the steps of:

a) forming internal electrodes on a plurality of dielectric layers such that the internal electrodes extend to respective lateral sides of the dielectric layers, and forming coil patterns on a plurality of magnetic layers such that the coil patterns extend to respective lateral sides of the magnetic layers;

b) performing, in an arbitrary order, formation of a capacitor part by laminating the plurality of dielectric layers, pressing the laminated dielectric layers, and then sintering the pressed dielectric layers to form a capacitor part, and formation of an inductor part by laminating the plurality of magnetic layers, pressing the laminated magnetic layers, and then sintering the pressed magnetic layers to form an inductor part;

c) bonding the capacitor part and inductor part using a glass-based adhesive; and

d) forming, on an outer surface of the resultant structure obtained from the step c) at least one external terminal connected to the internal electrodes extending to the lateral sides of the dielectric layers and/or to the coil patterns extending to the lateral sides of the magnetic layers.

Preferably, the step of bonding the capacitor part and inductor part may comprises the steps of:

c-1) applying the glass-based adhesive on at least one of bonding surfaces of the capacitor and inductor parts; and

c-2) arranging the capacitor and inductor parts such that their bonding surfaces face to each other and pressing the two parts together while heating the two parts at a desired temperature.

Preferably, the glass-based adhesive may be made of at least one composition selected from the group consisting of MgO—B₂O₃—SiO₂, CaO—B₂O₃—SiO₂, SnO—ZnO—P₂O₅, PbO—ZnO—B₂O₃, Bi₂O₃—B₂O₃, PbO—SiO₂, PbO—B₂O—SiO₂ and Al₂O₃—B₂O₃—SiO₂. The use of the above glass-based adhesive makes it possible to bond the capacitor and inductor parts by heating at 400 to 650° C. while resolving the problems of shrinkage occurring during the high temperature process.

The present invention is characterized in that capacitor and inductor parts are made through separate sintering processes and then bonded using a glass-based adhesive, so that the products thus manufactured avoid problems caused by the difference in shrinkages between the dielectric layer constituting the capacitor part and the magnetic layer constituting the inductor part occurring during a co-sintering process of the two layers. Accordingly, the present invention has advantages in that it can solve the problems of delamination and shape deformation occurring between dielectric and magnetic layers consisting of different materials, and simultaneously allow the compositions of the dielectric and magnetic layers to be freely designed without considering composition of a buffer layer, because of non-use of buffer layer limited in its composition.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a conventional laminated LC filter manufactured using a buffer layer; and

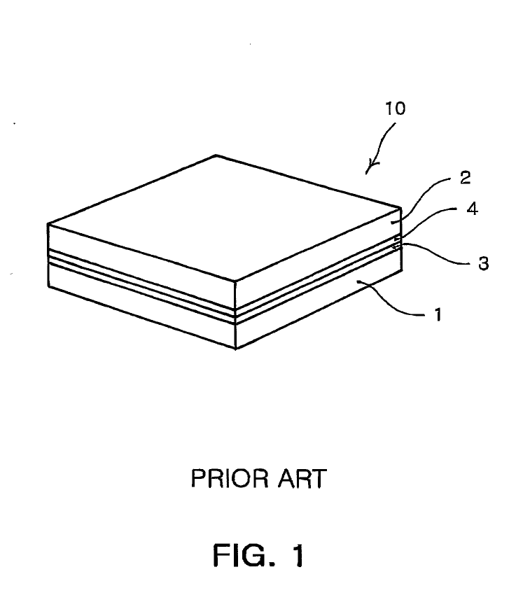

FIG. 2 is a flow chart illustrating a manufacturing method of a laminated LC filter according to the present invention.

### DESCRIPTION OF THE PREFERRED EMBODIMENTS

The present invention will hereinafter be described in more detail in reference to the accompanying drawings.

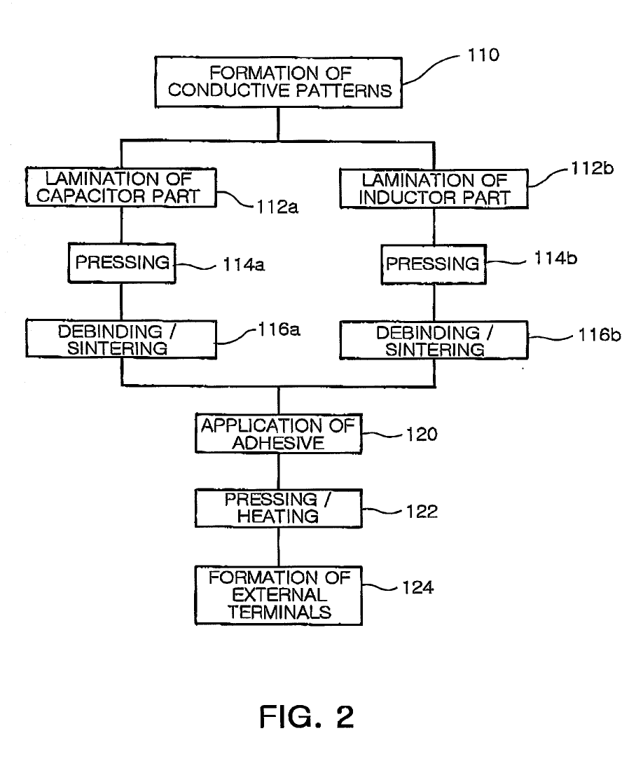

FIG. 2 is a flow chart illustrating a manufacturing method of a laminated LC filter according to the present invention. First, a plurality of dielectric and magnetic layers, each formed in the form of a green sheet, are prepared. The dielectric and magnetic layers are subjected to printing processes for printing internal electrodes and coil patterns, respectively (step 110).

The internal electrodes constitute capacitance elements, and the coil patterns constitute inductance elements. At this time, the internal electrodes and coil patterns are formed such that they extend to at least a part of the layers to be connected to external terminals to be formed in a subsequent process.

Next, the dielectric and magnetic layers are laminated, pressed, debinded and then sintered to form capacitor and inductor parts through separate processes. In more detail, the dielectric layers are laminated (step 112a). The laminated dielectric layers are pressed (step 114a). The pressed layers are sintered to form a sintered body corresponding to the capacitor part (step 116a). Meanwhile, the magnetic layers are laminated (step 112b). The laminated magnetic layers are pressed (step 114b). The pressed layers are sintered to form a sintered body corresponding to the inductor part (step 116b). At this time, it does not matter which part is made first. Also, the sintering temperature is generally about 1350° C., but the temperature can be selected in a range of about 1100 to 1500° C. based on materials constituting the dielectric and magnetic layers.

Thereafter, the capacitor part and the inductor part are bonded using a glass-based adhesive. Meanwhile, there has been no conventional method which bonds the capacitor and inductor parts after separately sintering these two laminated parts made using green sheets. As a result, during the co-sintering process of the dielectric and magnetic layers, there occurred problems caused by the difference in shrinkages between the two layers. Also, as described above, the method using buffer layers cannot be a fundamental solution and has wide limitations for determining compositions of the dielectric and the magnetic layers let alone the buffer layers. Therefore, the present invention uses the process of separately sintering the dielectric and magnetic layers, and bonding the capacitor and inductor parts obtained from respective sintering processes by an extra bonding process to fundamentally solve those problems.

According to the bonding process of the present invention, first, a glass-based adhesive is applied on at least one of the bonding surfaces of the capacitor and inductor parts (step 120). Thereafter, the capacitor and inductor parts are arranged so that their bonding surfaces face each other, and the two parts are pressed together while being heated at a desired temperature (step 122). In this way, the capacitor and inductor parts are bonded using a glass-based adhesive. At this time, since the adhesive is cured at a low temperature of about 400 to 850° C., it is possible to reduce problems caused by shrinkage generated at the sintering temperature of the dielectric and magnetic layers. The glass-based adhesive may includes a PbO—B₂O—CaO—SiO₂ based glass adhesive, an Al₂O₃—B₂O₃—CaO—SiO₂ based glass adhesive or so on. More preferably, a glass-based adhesive capable of being cured at a temperature of 650° C. or less can be used for minimizing problems by shrinkage of dielectric and magnetic layers. The glass-based adhesive may be made of at least one composition selected from the group consisting of MgO—B₂O₃—SiO₂, CaO—B₂O₃—SiO₂, SnO—ZnO—P₂O₅, PbO—ZnO—B₂O₃, Bi₂O₃—B₂O₃, PbO—SiO₂, PbO—B₂O—SiO₂ and Al₂O₃—B₂O₃—SiO₂.

Table 1 shows adhesives usable in the present invention and conditions of heating process (temperature and time) for curing the adhesives.

TABLE 1

| Composition | Heating temp. (° C.) | Heating time (min.) |
|---|---|---|
| MaO—B₂O₃—SiO₂ | 600 | 10 |
| CaO—B₂O₃—SiO₂ | 600 | 10 |
| SnO—ZnO—P₂O₅ | 490 | 10 |
| PbO—ZnO—B₂O₃ | 550 | 5 |
| Bi₂O₃—B₂O₃ | 460 | 30 |
| PbO—SiO₂ | 550 | 5 |
| PbO—B₂O—SiO₂ | 650 | 15 |
| Al₂O₃—B₂O₃—SiO₂ | 510 | 5 |

The present invention is not limited to the above compositions, and those skilled in the art will appreciate that adhesives usable as a binder at a low temperature can be sufficiently used as the adhesive of the present invention.

Thereafter, external terminals are formed on the lateral surfaces of the resultant structure obtained from the bonding process (step 124). The formation position of the external terminals can be defined by appropriately designing portions of the internal electrodes and coil patterns, which extend to the lateral surfaces of the printed silver paste. The external terminals are formed by printing silver (Ag) paste on the corresponding surfaces of the bonded structure and then sintering the bonded structure. At this time, the sintering is performed at a low temperature (about, 680° C.), so that it dose not adversely affect the configuration and structure of the sintered structure.

As described above, in accordance with the present invention, dielectric and magnetic layers are sintered through separate processes, and then bonded to each other, without using a co-sintering process carried out at a high temperature, so that it is possible to essentially prevent delamination and distortion phenomena occurring due to the difference in shrinkages.

As apparent from the above description, the LC filter manufacturing method according to the present invention involves the steps of forming capacitor and inductor parts through separate sintering processes, and then bonding the two parts using a glass-based adhesive. Accordingly, the present invention can solve problems of delamination and shape deformation caused by the difference in shrinkages occurring during a co-sintering process of the dielectric layers constituting the capacitor part and the magnetic layers constituting the inductor part. Also, since the present invention does not use any extra buffer layer, there is no need to consider the shrinkage reduction and the composition of the buffer layer, and so the compositions of the dielectric and magnetic layers can be freely designed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for manufacturing a laminated LC filter, comprising the steps of;
a) forming internal electrodes on a plurality of dielectric layers such that the internal electrodes extend to respective lateral sides of the dielectric layers, and forming coil patterns on a plurality of magnetic layers such that the coil patterns extend to respective lateral sides of the magnetic layers;
b) performing, in an arbitrary order, formation of a capacitor part by laminating the plurality of dielectric layers, pressing the laminated dielectric layers, and then sintering the pressed dielectric layers to form a capacitor part, and formation of an inductor part by laminating the plurality of magnetic layers, pressing the laminated magnetic layers, and then sintering the pressed magnetic layers to form an inductor part;
c) bonding the capacitor part and inductor part using a glass-based adhesive; and
d) forming, on an outer surface of the resultant structure obtained from the step c) at least one external terminal connected to the internal electrodes extending to the lateral sides of the dielectric layers and/or to the coil patterns extending to the lateral sides of the magnetic layers.

2. The method as set forth in claim 1, wherein the step c) comprises the steps of:
c-1) applying the glass-based adhesive on at least one of bonding surfaces of the capacitor and inductor parts; and
c-2) arranging the capacitor and inductor parts such that their bonding surfaces face to each other and pressing the two parts together while heating the two parts at a desired temperature.

3. The method as set forth in claim 1 or 2, wherein, the glass-based adhesive is made of at least one composition selected from the group consisting of MgO—B₂O₃—SiO₂, CaO—B₂O₃—SiO₂, SnO—ZnO—P₂O₅, PbO—ZnO—B₂O₃, Bi₂O₃—B₂O₃, PbO—SiO₂, PbO—B₂O—SiO₂ and Al₂O₃—B₂O₃—SiO₂.

4. The method as set forth in claim 3, wherein the capacitor and inductor parts are heated at a temperature of about 400 to 650° C. such that they are bonded to each other.

5. The method as set forth in claim 1, wherein the sintering at the step b) is performed at a temperature of about 1100 to 1500° C.

6. The method as set forth in claim 1, wherein the formation of the external terminal at the step d) is carried out by printing silver (Ag) paste at an external terminal forming region which is located at la lateral surface of the resultant structure obtained from the step c).
